(19) United States
(12) Patent Application Publication
(10) Pub. No.: US 2010/0025887 A1
(43) Pub. Date: Feb. 4, 2010

(54) PROCESS AND APPARATUS FOR PRODUCING A STRAND-LIKE EXTRUDATE

(75) Inventors: Reiner Lay, Aachen (DE); Paul Wynen, Neerpelt (BE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/516,009

(22) PCT Filed: Dec. 3, 2007
(86) PCT No.: PCT/EP2007/063162

§ 371 Date: May 22, 2009

(30) Foreign Application Priority Data
Dec. 19, 2006 (DE) 10 2006 059 932.2

(51) Int. Cl. B29C 71/02; D01D 5/084

(52) U.S. Cl. 264/236; 425/67

(57) ABSTRACT

The invention relates to a process for producing a strand-like extrudate (5) composed of a rubber material which is vulcanized after extrusion, in which the vulcanization is carried out in a bath (7) by means of heat treatment medium (9) present therein. The strand-like extrudate (5) is transported through the heat treatment medium (9) in an essentially vertical direction. The invention further relates to an apparatus for carrying out the process, in which the bath (7) is configured in the form of a closed channel which has openings for entry and exit of the strand-like extrudate (5) and is arranged so that the strand like extrudate (5) can be conveyed through it in an essentially vertical direction.

### BACKGROUND OF THE INVENTION

The invention relates to a process for producing a strand-like extrudate. Furthermore, the invention relates to an apparatus for producing a strand-like extrudate.

Strand-like extrudates of a rubber material are used, for example, for producing wiper blade elements, in particular wiper blade elements for windshield wipers of motor vehicles. The rubber material for the strand-like extrudate is usually a partially crosslinked elastomer. During production, this extrudate is subjected to vulcanization. The vulcanization is usually carried out after the extrusion of the strand-like extrudate. For this purpose, the strand-like extrudate is heated to the vulcanization temperature after leaving the extruder. This takes place, for example, in a bath which contains a molten salt.

The molten salt is usually provided in a channel through which the extrudate is passed in a horizontal direction. In order to avoid tearing of the extrudate, it is usually on a transporting device, which is generally in the form of a transporting belt. A disadvantage of using a transporting belt is that it tends to stick to the profile of the strand-like extrudate and cause deformations.

A further disadvantage of the bath known from the prior art is that it is usually open at the top. On account of the horizontal transport of the extrudate through the bath, the free surface area is very large. As a result, it is only possible with very great effort to extract emissions from the salt bath and discharge them into the surrounding air.

The production of wiper blades by extrusion and subsequent vulcanization is described, for example, in DE-A 10 2005 000 851.

### SUMMARY OF THE INVENTION

In the case of the process according to the invention for producing a strand-like extrudate from a rubber material which is vulcanized after extrusion, the vulcanization takes place in a bath with heat treatment medium contained in it. The strand-like extrudate is moved through the heat treatment medium in a substantially vertical direction.

For the purposes of the present invention, “in a substantially vertical direction” also includes a deviation from the vertical, that is to say the direction parallel to the direction in which gravitational force acts, of up to 5°.

The fact that the strand-like extrudate is moved through the heat treatment medium in a substantially vertical direction means that it is not deformed by gravitational force. An advantage of this is that profile geometries with very small wall thicknesses are possible as a result.

A further advantage of being passed through the bath with the heat treatment medium substantially vertically is that, at the end of the vulcanization process, the heat treatment medium flows back into the bath along the strand-like extrudate. As a result, losses of heat treatment medium are minimized.

In a preferred embodiment, the strand-like extrudate is transported in a freely floating manner through the bath with the heat treatment medium contained in it. This means that it is possible to dispense with a transporting means, for example a transporting belt, such as that known from the prior art. Consequently, the strand-like extrudate can no longer stick to the transporting means and be deformed as a result.

The transporting of the strand-like extrudate through the heat treatment medium preferably takes place from the bottom upward. Consequently, on account of the hydrostatic pressure of the heat treatment medium, the highest pressure is at the entry into the bath. With a height of the bath of 7 to 10 m, this highest pressure is up to 2 bar. The vulcanization consequently takes place initially under this pressure. As a result, porosities of the strand-like extrudate are reduced and possibly prevented.

The apparatus according to the invention for carrying out the process described above comprises at least one bath with heat treatment medium contained in it, the bath preferably being in the form of a closed channel with openings for the entering and exiting of the strand-like extrudate which is arranged in such a way that the strand-like extrudate can be passed through it in a substantially vertical direction.

On account of the strand-like extrudate being passed through vertically, it is possible to form the bath with a small cross section and a great length. It is possible for just the small cross section on the upper side to be open toward the surroundings. An advantage of this configuration is that the open surface area of the heat treatment medium is very small, as a result of which emissions to the surrounding air are spatially very limited and consequently can be easily extracted.

In a preferred embodiment, the bath with the heat treatment medium contained in it is heatable. As an alternative or in addition to the heating, it is preferred for the bath with the heat treatment medium contained in it to be thermally insulated with respect to the surroundings.

On account of the small cross section in comparison with the length of the bath and the only small free surface area toward the open surroundings, only a small amount of heat is given off to the surroundings by the bath. Less energy is necessary to keep the heat treatment medium at the required temperature. The thermal insulation allows the heat that is given off to the surroundings to be reduced further. Consequently, the bath formed according to the invention can be heated in a very cost-saving manner.

According to a further embodiment of the present invention, it is possible for at least one deflection roller around which the strand-like extrudate is deflected to be provided in the bath with the heat treatment medium contained in it. Deflecting the extrudate makes it possible to reduce the length of the bath while the time for which the strand-like extrudate stays in the heat treatment medium remains the same. In the case of this embodiment, the strand-like extrudate is transported through the bath initially in a vertical direction, in the direction of gravitational force, is led around the deflection roller and is subsequently transported likewise in a vertical direction, counter to the direction of gravitational force, until it is removed from the bath. Alternatively, it is also possible to pass the strand-like extrudate through the heat treatment medium initially in a substantially vertical direction, counter to the direction of gravitational force, then around the deflection roller and subsequently in a substantially vertical direction, in the direction of gravitational force.

In order to achieve the time for which the extrudate stays in the heat treatment medium that is required for vulcanization, the bath preferably has a height in the range from 5 to 18 m, in particular in the range from 7 to 10 m.

In order to achieve the temperature required for vulcanization, the heat treatment medium in the bath is preferably a molten salt. The temperature is preferably in the range from 160 to 240° C.

### BRIEF DESCRIPTION OF THE DRAWINGS

Exemplary embodiments of the invention are explained in more detail in the description which follows and are represented in the drawings, in which:

FIG. 1 shows an apparatus formed according to the invention in a first embodiment,

FIG. 2 shows an apparatus formed according to the invention in a second embodiment.

### DETAILED DESCRIPTION

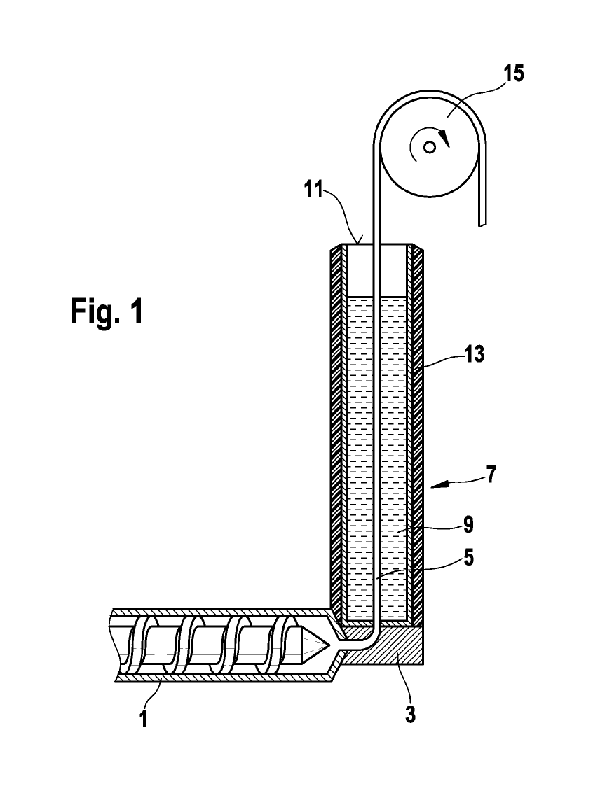

In FIG. 1, an apparatus formed according to the invention in a first embodiment is represented.

An apparatus formed according to the invention comprises an extruder 1, which is only schematically represented here. Extruders 1 are conventional machines in polymer processing and are known to a person skilled in the art.

In the extruder 1, a polymer mixture is plasticated and formed into a strand-like extrudate 5 by a die 3. The strand-like extrudate 5 is usually a continuous strand.

According to the invention, the polymer material which is plasticated in the extruder 1 is a rubber material. Such rubber materials are, for example, natural rubber or synthetic types of rubber such as chloroprene rubber or EPDM. Furthermore, silicone rubber or polyurethane rubber is also suitable as the rubber material. The rubber material may also comprise a copolymer of isoprene and/or at least one further polymerizable monomer.

The die 3, through which the plasticated rubber material is forced, is usually a die that has a cross section which corresponds to the cross section of the strand-like extrudate 5 to be produced. A strand-like extrudate 5 of any desired cross section can be produced by extrusion.

After the extrusion, the strand-like extrudate 5 is fed to a bath 7, in which a heat treatment medium 9 is contained. The heat treatment medium 9 is preferably a molten salt. Suitable salts for the molten salt are, for example, mixtures of lithium nitrate and potassium nitrate or else mixtures of potassium nitrate, sodium nitrate and sodium nitrite.

According to the invention, the bath 7 is configured in such a way that the strand-like extrudate 5 is passed through it in a substantially vertical direction. According to the embodiment represented in FIG. 1, the strand-like extrudate 5 is fed to the bath 7 at the bottom and transported upward, counter to the direction of gravitational force. The bath 7 is in this case configured, for example, in the form of a pipe. This pipe is open on its upper side, at which the strand-like extrudate 5 is removed. Since the strand-like extrudate 5 is passed through the bath 7 in a vertical direction, it is possible to configure the bath 7 with a small diameter. As a result, the cross section of the bath 7 is small in comparison with its length. This leads to a small free surface area with respect to the surroundings at which emissions can be given off to the surroundings. On account of the small cross section of the open surface 11 of the bath 7, it is possible for the emissions to be easily extracted and discharged. It is not necessary, as in the case of the baths aligned in a horizontal direction that are known from the prior art, to provide an extraction device which extends over the entire length of the bath. Moreover, the emissions to the surroundings are very much smaller.

The strand-like extrudate 5 is preferably likewise removed from the heat treatment medium 9 in a substantially vertical direction. An advantage of this is that the heat treatment medium 9 flows back into the bath 7 along the strand-like extrudate 5. The loss of heat treatment medium 9 is consequently minimized.

Since the strand-like extrudate is passed through the heat treatment medium 9 in the bath 7 in a vertical direction, it is not necessary to provide within the bath 7 a transporting means with which the strand-like extrudate is transported. The strand-like extrudate 5 floats freely in the heat treatment medium 9. This avoids the possibility of the strand-like extrudate 5 sticking to a transporting means, whereby deformations can occur. On account of the direction of movement counter to the direction of gravitational force, deformations of the strand-like extrudate attributable to a gravitational influence acting transversely to the transporting direction of the strand-like extrudate 5 are also avoided.

The time for which the strand-like extrudate 5 stays in the heat treatment medium 9 is dependent on the transporting rate of the strand-like extrudate 5 and the height of the bath 7.

With the extrusion rates and required vulcanization times known from the prior art, a height of the bath 7 in the range from 5 to 18 m, with preference in the range from 7 to 10 m, is obtained.

The height of the bath 7 with the heat treatment medium 9 contained in it causes a hydrostatic pressure in the bath 7 that is in the range of about 2 bar at the entry of the strand-like extrudate 5 into the bath 7. On account of this pressure, the formation of porosities in the strand-like extrudate is avoided.

In order to avoid heat losses to the surroundings, the bath 7 is preferably provided with an outer insulation 13. Any material known to a person skilled in the art that can be used for thermal insulation is suitable as the material for the outer insulation 13. When choosing the material for the outer insulation 13, it just has to be ensured that it is stable with respect to the temperatures which occur on the outer surface of the bath 7.

In order to transport the strand-like extrudate 5 through the bath 7, a transporting roller 15, around which the strand-like extrudate 5 is led, is provided for example. In this case, the circumferential speed of the transporting roller 15 corresponds to the rate at which the strand-like extrudate 5 must be transported through the heat treatment medium 9 in the bath 7 to achieve a uniform profile. Apart from a single transporting roller 15, as represented in FIG. 1, it is of course also possible to provide a combination of a number of rollers. In this respect it is possible for either all the rollers to be driven or for only some of the rollers to be driven. The rollers may in this case lie opposite one another, for example, so that the strand-like extrudate 5 is respectively led through between two or more rollers, but they may also be arranged in an alternating manner, so that the strand-like extrudate 5 is led around the transporting rollers 15 in a meandering manner. Furthermore, combinations of rollers lying next to one another and lying opposite one another are also conceivable.

The vulcanization carried out in the bath 7 may be followed by further processing steps for the strand-like extrudate 5. For example, it is possible for the strand-like extrudate 5 to be coated in a further processing step.

The extruder 1 and the bath 7 are preferably arranged in such a way that the strand-like extrudate 5 is extruded directly from the die 3 into the bath 7. In this way it is not necessary to provide the bath 7 with a feeding device which seals off the entering strand-like extrudate 5 in such a way that no heat treatment medium 9 can run out of the bath 7. Since the pressure at the die 3 of the extruder 1 usually exceeds the hydrostatic pressure of the heat treatment medium 9 in the bath 7, no heat treatment medium 9 will flow into the extruder 1 even if the bath 7 directly adjoins the die 3.

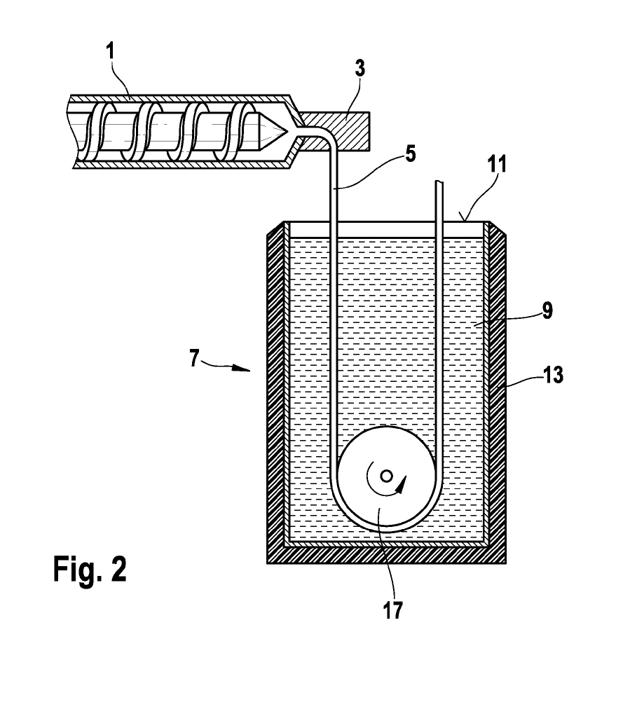

In FIG. 2, an apparatus formed according to the invention in a second embodiment is represented.

In the case of the embodiment represented in FIG. 2, the plasticated rubber material is forced out of the extruder 1 through the die 3 as a strand-like extrudate 5. The strand-like extrudate 5 moves initially in a vertical direction, in the direction of gravitational force, into the heat treatment medium 9 in the bath 7 for vulcanization. Provided in the bath 7 is a deflection roller 17, around which the strand-like extrudate 5 is led. After passing the deflection roller 17, the strand-like extrudate is transported further through the bath 7 in a substantially vertical direction, counter to the direction of gravitational force, until it once again reaches the open surface 11. Here, the strand-like extrudate 5 leaves the heat treatment medium 9. The transporting of the strand-like extrudate 5 through the heat treatment medium 9 is usually performed here by means of a transporting device, which however is not represented in FIG. 2. The transporting device may be, for example, a transporting roller 15, over which the strand-like extrudate 5 is led after it has left the bath 7.

An advantage of the embodiment represented in FIG. 2 over the embodiment represented in FIG. 1 is that, with the strand-like extrudate moving at the same rate and staying in it for the same time, the bath 7 only has to be half the height. However, the fact that the strand-like extrudate 5 enters via the open surface 11 of the heat treatment medium 9 means that the pressure acting on the strand-like extrudate 5 initially increases and subsequently decreases again. The strand-like extrudate 5 is not made to enter the heat treatment medium 9 at the highest pressure.

It is also the case in the embodiment represented in FIG. 2 that the open surface 11 is small in comparison with the height of the bath 7. Consequently, here too the emissions are small in comparison with a bath extending in a horizontal direction and can be easily extracted and discharged.

As an alternative to the embodiment represented here, in which the strand-like extrudate initially runs around a deflection roller and is drawn off via the open surface 11 of the bath 7, it is also possible for the strand-like extrudate 5 to be removed from the bath 7 downwardly by way of an outlet device. However, the outlet device must then be configured in such a way that no heat treatment medium 9 can flow out of the bath 7. It is consequently necessary to seal off the strand-like extrudate 5 at the removal device. In comparison, it is an advantage of the embodiment with a deflection roller 17 that the strand-like extrudate 5 is removed upwardly and any heat treatment medium 9 that is entrained with the strand-like extrudate 5 runs back into the bath 7.

Both in the case of the embodiment represented in FIG. 1 and in the case of the embodiment represented in FIG. 2, the heating of the heat treatment medium 9 may take place via the surface of the bath 7. For this purpose, for example, heating is provided instead of the outer insulation 13. Furthermore, it is also possible for heating to be provided between the outer insulation 13 and the wall of the bath 7. As an alternative to this, it is of course also possible for heating for the heat treatment medium 9 to be provided in the bath 7. In a further alternative embodiment, the heat treatment medium 9 is pumped around, that is to say is removed from the bath 7 by way of a heat treatment medium discharge and is made to enter the bath 7 by way of a heat treatment medium feed, the temperature control of the heat treatment medium 9 taking place outside the bath, for example by means of a heat exchanger. As already mentioned above, the heat treatment medium 9 is preferably a molten salt.

1. Process for producing a strand-like extrudate (5) from a rubber material which is vulcanized after extrusion, the vulcanization taking place in a bath (7) with heat treatment medium (9) contained in it, characterized in that the strand-like extrudate (5) is moved through the heat treatment medium (9) in a substantially vertical direction.

2. The process as claimed in claim 1, characterized in that the strand-like extrudate (5) is transported in a freely floating manner through the bath (7) with the heat treatment medium (9) contained in it.

3. The process as claimed in claim 1, characterized in that the transporting of the strand-like extrudate (5) through the bath (7) with the heat treatment medium (9) contained in it takes place from the bottom upward.

4. The process as claimed in claim 1, characterized in that the strand-like extrudate (5) is a wiper blade element, in particular a wiper blade element for windshield wipers of a motor vehicle.

5. An apparatus for producing a strand-like extrudate (5) from a rubber material which is vulcanized after extrusion, the apparatus comprising at least one bath (7) with heat treatment medium (9) contained in it, characterized in that the bath (7) is in the form of a closed channel with openings for the entering and exiting of the strand-like extrudate (5) which is arranged in such a way that the strand-like extrudate (5) can be passed through it in a substantially vertical direction to vulcanize the rubber material.

6. The apparatus as claimed in claim 5, characterized in that the bath (7) with the heat treatment medium (9) contained in it directly adjoins a die (3) of an extruder (1), so that the strand-like extrudate (5) is extruded directly into the heat treatment medium (9).

7. The apparatus as claimed in claim 5, characterized in that the strand-like extrudate (5) is made to enter the heat treatment medium (9) and removed again via a surface (11) that is open toward the surroundings.

8. The apparatus as claimed in claim 5, characterized in that the bath (7) with the heat treatment medium (9) contained in it is heatable.

9. The apparatus as claimed in claim 5, characterized in that the bath (7) with the heat treatment medium (9) contained in it is thermally insulated with respect to the surroundings.

10. The apparatus as claimed in claim 5, characterized in that at least one deflection roller (17), around which the strand-like extrudate (5) is deflected, is provided in the bath (7) with the heat treatment medium (9) contained in it.

11. The apparatus as claimed in claim 5, characterized in that the bath (7) with the heat treatment medium (9) contained in it has a height in the range from 5 to 18 m.

12. The apparatus as claimed in claim 5, characterized in that the heat treatment medium (9) is a molten salt.

13. The apparatus as claimed in claim 5, further comprising means for causing the strand-like extrudate (5) to enter the heat treatment medium (9) via a surface (11) that is open toward the surroundings, and for removing the extrudate (5) from the heat treatment medium (9) via a surface (11).

14. The apparatus as claimed in claim 5, further comprising means for heating the bath.
